(19) United States
(12) Patent Application Publication
(10) Pub. No.: US 2012/0050164 A1
(43) Pub. Date: Mar. 1, 2012

(54) Computer Mouse Input Device

(76) Inventor: Burton M. Martel, Winnipeg (CA)

(21) Appl. No.: 13/033,662

(22) Filed: Feb. 24, 2011

Related U.S. Application Data
(60) Provisional application No. 61/307,518, filed on Feb. 24, 2010.

(51) Int. Cl. G06F 3/033

(52) U.S. Cl. 345/163

(57) ABSTRACT

A computer mouse input device has a housing gripped in a hand of the user with a strap member projecting from the rear of the housing to receive a finger of the user therethrough when a cursor tracking mechanism is supported on the front face of the housing so as to be arranged to receive input from a thumb of the same hand of the user. The left-click button is positioned on the side of the housing so as to be arranged to be accessible by the same finger of the user which is received in the strap member. The housing is small enough to be readily pivoted about the finger of the user between a working position in the palm of the hand of the user and a stored position at the back of the hand of the user so as not to interfere with typing when stored.

This application claims the benefit under 35 U.S.C.119(e) of U.S. provisional application Ser. No. 61/307,518, filed Feb. 24, 2010.

### FIELD OF THE INVENTION

The present invention relates to an input device for a computer, for example a computer mouse, in which cursor tracking inputs from a user can be input into a computer, and more particularly the present invention relates to a computer mouse type input device which can be worn on a finger of the user.

### BACKGROUND

Various types of computer input devices are known. The most common example, a conventional computer mouse is known to cause considerable strain when used repetitively. Furthermore it is cumbersome to repetitively alternate between use of a keyboard and a mouse during certain computer operations.

Various examples of computer input devices are disclosed in U.S. Pat. Nos. 7,092,785 by Alsio et al and 6,850,224 by Baughman and United States Patent Application Publication 2003/0214481 by Xiong. Each of the devices is awkward to use, potentially causing strain, and does not readily permit alternate use of a keyboard in an efficient manner.

### SUMMARY OF THE INVENTION

According to one aspect of the invention there is provided a computer mouse input device arranged for transmitting inputs from a user to a computer, the device comprising:

a housing arranged to be gripped in a hand of the user, the housing having opposing front and rear faces which extend in a longitudinal direction between opposing top and bottom ends, and a pair of sides extending in the longitudinal direction along opposing sides of the front and rear faces;

a strap member supported on the housing to project from the rear face, the strap member defining an opening between the strap member and the rear face which extends in a lateral direction across the rear face perpendicularly to the longitudinal direction so as to be arranged to receive a finger of said hand of the user extending in the lateral direction therethrough between the strap member and the rear face of the housing;

the strap member being arranged to receive the finger of the user therein such that the housing is readily pivotal from a working position in which the housing is arranged to be located adjacent a palm of said hand of the user and a stored position adjacent a back side of said hand of the user opposite the palm; and

a cursor tracking mechanism supported on the front face of the housing and arranged to receive a cursor tracking input from the user to control a cursor position on a desktop environment of the computer;

the cursor tracking mechanism being positioned on the front face of the housing so as to be arranged to receive input from a thumb of said hand of the user in the working position of the housing.

The input device may further comprise a click button on one of the sides of the housing in which the click button is arranged to generate a computer left-click signal when depressed by a user and in which the click button is positioned on the side of the housing so as to be arranged to be accessible by said finger of the user which is received in the strap member.

By providing a housing on a strap member which can be readily pivoted about the finger of the user between working and stored positions, the computer input device of the present invention is readily adapted for alternating use with a keyboard in an efficient manner. Furthermore, the configuration of the housing which is arranged to be readily grasped within the hand of the user in the working position while providing access by the thumb for inputting cursor tracking movements results in a simple design which minimizes strain to the user.

Preferably an upward input on the cursor tracking mechanism towards the top end of the housing in the longitudinal direction is arranged to generate an upward signal corresponding to an upward movement of the cursor position in the desktop environment of the computer.

The strap member may be adjustable in relation to the housing such that a dimension of the opening between the strap member and the rear face is adjustable.

In one embodiment, a first click button on one of the sides of the housing is arranged to generate a left-click signal when depressed by a user and a second click button on the top end of the housing is arranged to generate a right-click signal when depressed by a user.

Alternatively there is provided a first click button on one of the sides of the housing which is arranged to generate a left-click signal when depressed by a user and a second click button independently located on the same side of the housing which is arranged to generate a right-click signal when depressed by a user.

In a further embodiment, a click button is provided on one of the sides of the housing and a toggle switch is independently located on the housing. In this instance, the click button may be arranged to generate a left-click signal when depressed by a user in a first mode of the toggle switch and may be arranged to generate a right-click signal when depressed by a user in a second mode of the toggle switch.

A connecting member arranged for connection to the computer is preferably coupled to the top end of the housing.

According to a second aspect of the present invention there is provided a computer mouse input device arranged for transmitting inputs from a user to a computer, the device comprising:

a housing arranged to be gripped in a hand of the user, the housing having opposing front and rear faces which extend in a longitudinal direction between opposing top and bottom ends, and a pair of sides extending in the longitudinal direction along opposing sides of the front and rear faces;

a strap member supported on the housing to project from the rear face, the strap member defining an opening between the strap member and the rear face which extends in a lateral direction across the rear face perpendicularly to the longitudinal direction so as to be arranged to receive a finger of said hand of the user extending in the lateral direction therethrough between the strap member and the rear face of the housing;

the strap member being arranged to receive the finger of the user therein such that the housing is readily pivotal from a working position in which the housing is arranged to be located adjacent a palm of said hand of the user and a stored position adjacent a back side of said hand of the user opposite the palm;

a cursor tracking mechanism supported on the front face of the housing and arranged to receive a cursor tracking input from the user to control a cursor position on a desktop environment of the computer;

the cursor tracking mechanism being positioned on the front face of the housing so as to be arranged to receive input from a thumb of said hand of the user in the working position of the housing;

a click button on one of the sides of the housing, the click button being arranged to generate a computer left-click signal when depressed by a user;

the click button being positioned on the side of the housing so as to be arranged to be accessible by said finger of the user which is received in the strap member.

According to another aspect of the present invention there is provided a method of providing inputs to a computer, the method comprising:

providing an input device comprising: a housing having opposing front and rear faces which extend in a longitudinal direction between opposing top and bottom ends, and a pair of sides extending in the longitudinal direction along opposing sides of the front and rear faces; a strap member supported on the housing to project from the rear face and defining an opening between the strap member and the rear face which extends in a lateral direction across the rear face perpendicularly to the longitudinal direction; and a cursor tracking mechanism supported on the front face of the housing and arranged to receive a cursor tracking input from the user to control a cursor position on a desktop environment of the computer;

inserting a finger of a hand of the user in the lateral direction through the opening between the strap member and the rear face of the housing such that the housing is arranged to be gripped in the hand of the user;

controlling the cursor tracking mechanism by providing inputs using a thumb of said hand of the user within which the housing is gripped in a working position of the housing located adjacent a palm of said hand of the user; and

pivoting the housing about said finger of the user received between the strap member and the rear face of the housing from the working position to a stored position adjacent a back side of said hand of the user opposite the palm.

The method preferably includes providing a click button on one of the sides of the housing and generating a computer click signal by depressing the button with a finger of the user. More preferably the button is depressed by the same finger of the user which is received between the strap member and the rear face of the housing. The click button preferably corresponds to a left-click signal.

The method may also include generating an upward signal corresponding to an upward movement of the cursor position in the desktop environment of the computer by providing an upward input on the cursor tracking mechanism towards the top end of the housing in the longitudinal direction thereof.

Some embodiments of the invention will now be described in conjunction with the accompanying drawings in which:

### BRIEF DESCRIPTION OF THE DRAWINGS

FIG. 1 is a perspective view of the computer mouse input device.

FIG. 2 is a front view of the computer mouse input device.

FIG. 3 is a rear view of the computer mouse input device.

FIG. 4 is a side view of the computer mouse input device.

FIG. 5 is a perspective view of the computer mouse input device on a hand of the user in a working position.

FIG. 6 is a perspective view of the computer mouse input device on the hand of the user in a storage position.

In the drawings like characters of reference indicate corresponding parts in the different figures.

### DETAILED DESCRIPTION

Referring to the accompanying figures there is illustrated a computer input device generally indicated by reference numeral 10. The device 10 is suited for use with a computer for inputting various operations including left click operations, right click operations, and cursor movements in the virtual desktop environment of the computer.

The device 10 generally comprises a housing 12 which is rectangular in shape and suitably sized to be readily grasped within the palm of the hand of the user. The housing includes a front face 14 and an opposing rear face 16 which is generally parallel and spaced apart from the front face. Each of the front and rear faces is elongate in a longitudinal direction of the housing between a top end 18 and a bottom end 20 thereof.

Two sides 22 extend along opposing sides of the front and rear faces to be spanning the thickness of the housing between the front and rear faces as well as spanning in the longitudinal direction of the housing between the top and bottom ends thereof. In the preferred embodiment, the housing has a length in the longitudinal direction corresponding approximately to two inches and a thickness between front and rear faces of approximately half an inch. The width in a lateral direction across the faces perpendicular to the longitudinal direction corresponds to approximately one inch.

The device 10 further comprises a strap member 24 mounted on the rear face to span generally in the longitudinal direction of the housing between opposing ends of the strap which are joined to the rear face. The opposing ends are joined to the rear face adjacent the top and bottom ends respectively to define an opening between the strap and the rear face of the housing which extends generally in the lateral direction of the housing to slidably receive a single finger of the user therethrough in the lateral direction. In preferred embodiments a middle finger of the user is readily received within the opening between the strap member and the rear face of the housing, however, in alternate configurations the user may insert the index finger into the opening of the strap member.

In either instance, the strap member 24 permits the housing to be generally pivotal about a lateral axis extending through the opening of the strap member such that the housing is pivotal about the finger received therein between a working position on an inside of the hand of the user and a stored position on an outside of the hand of the user. More particularly in the working position, the housing is located adjacent the palm of the hand of the user with the front face being readily accessible by the thumb of the user. Alternatively in the stored position the housing is located on the back side of the hand opposite the palm of the hand such that the housing does not obstruct a typing interaction of the user with the keyboard.

The device 10 further comprises a cursor tracking mechanism 26 supported centrally on the front face to receive cursor tracking inputs from the thumb of the user. The mechanism 26 typically comprises a touch pad arranged to detect sliding intractions of the thumb of the user with the pad. In further embodiments however the tracking mechanism may comprise a ball or joystick similar to other computer input devices. The tracking mechanism 26 is oriented such that an upward user input in a vertical or longitudinal direction towards the top end of the housing corresponds to an upward signal being generated and communicated to the computer to result in a corresponding upward movement of the cursor in the desktop environment of the computer.

The device 10 further comprises a left click button 28 mounted on the outer one of the two sides 22 of the housing nearer to the fingertips of the user and opposite from the base of the hand of the user within which the housing 12 is supported. The left click button 28 is centrally located on the corresponding side 22 of the housing so as to be readily accessible by the same finger which is received within the opening of the strap member. Depressing the left click button 28 generates a suitable left click signal to be communicated to the computer for executing a left click operation.

A right click function of the device 10 can be generated also by the left click button 28 by using a toggle switch 30 which alternates the mode of the click button 28 between a left click mode where the button generates a left click signal and a right click mode in which contacting the button 28 by the user generates a corresponding right click signal. The toggle switch 30 in this instance is typically located on the front face of the housing adjacent the bottom end thereof to be readily contacted by the fingers of the user.

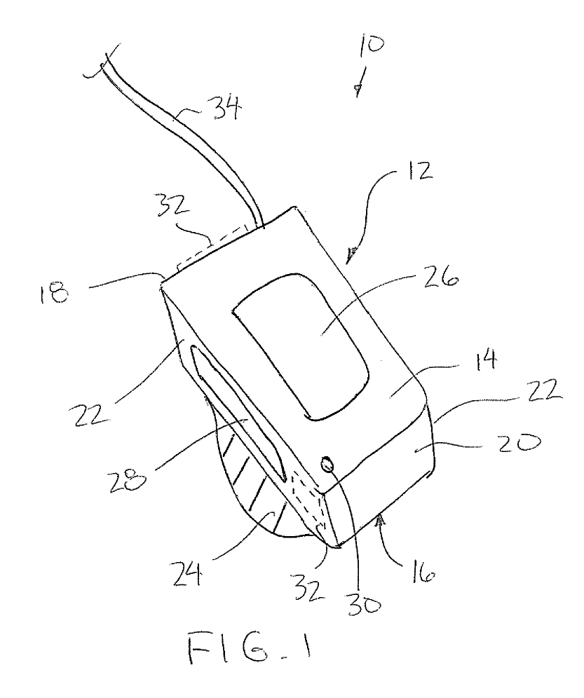

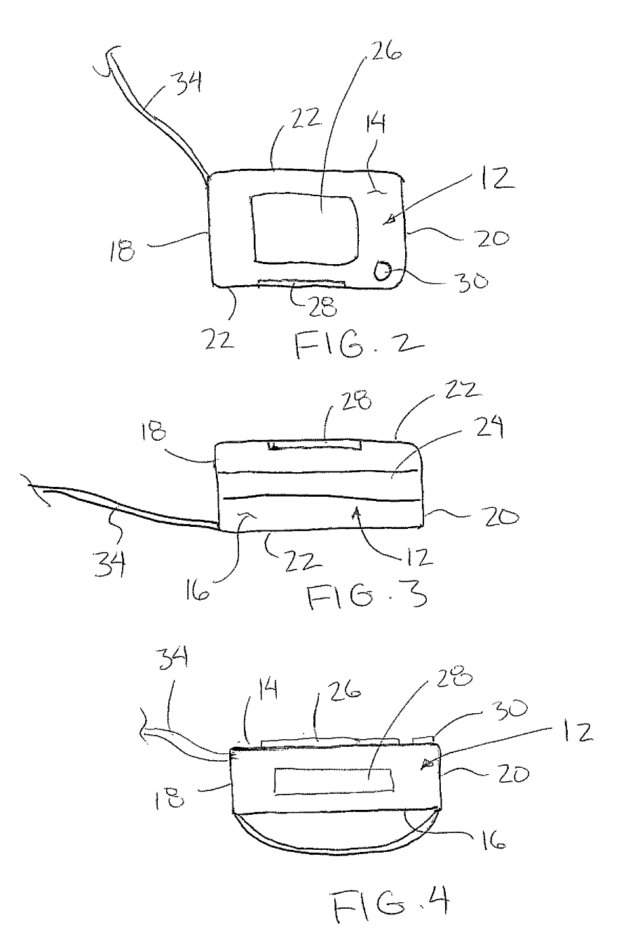

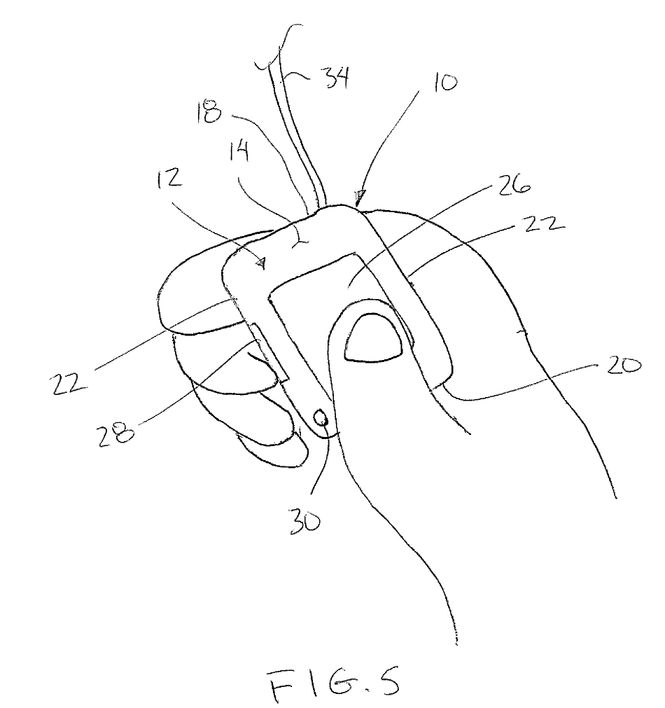

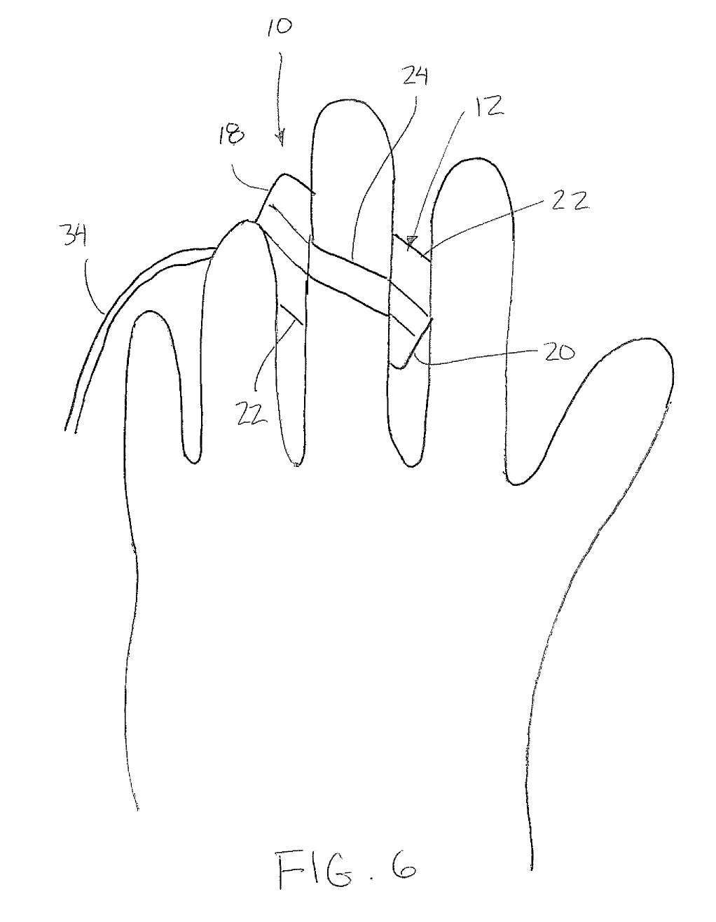

In alternative configurations, a separate right click button 32 may be provided on the housing which may be operated independently of the left click button to generate the right click signal. In this instance, the right click button 32 may be located on the same side of the housing as the left click button, at a position spaced closer to the bottom end as show in broken line in FIG. 1. In yet a further embodiment the right click button 32 may be mounted on the top end of the housing for contact with the index finger or thumb of the user as may be desired, also as shown in broken line in FIG. 1.

The device 10 further comprises a connection member 34 in the form of an elongate flexible cable mounted on the top end of the housing at one end and arranged for connection to the computer at the opposing end. The connection member 34 serves to convey signals generated by the device 10 to the computer.

In use, a user inserts the middle finger of the desired hand into the opening of the strap member to position the device in the working position such that the cursor tracking mechanism is readily adaptable with the thumb and the left click button 28 is readily accessible by the same finger received through the opening of the strap member. The user is then permitted to input various click operations and tracking operations as may be desired. When it is desirable to use the key board, the housing is readily flipped by pivoting 180 degrees about the finger received through the opening of the strap member to displace the housing from the working position to the storage position at the back side of the hand of the user where it does not interfere with typing operations.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A computer mouse input device arranged for transmitting inputs from a user to a computer, the device comprising:
a housing arranged to be gripped in a hand of the user, the housing having opposing front and rear faces which extend in a longitudinal direction between opposing top and bottom ends, and a pair of sides extending in the longitudinal direction along opposing sides of the front and rear faces;
a strap member supported on the housing to project from the rear face, the strap member defining an opening between the strap member and the rear face which extends in a lateral direction across the rear face perpendicularly to the longitudinal direction so as to be arranged to receive a finger of said hand of the user extending in the lateral direction therethrough between the strap member and the rear face of the housing;
the strap member being arranged to receive the finger of the user therein such that the housing is readily pivotal from a working position in which the housing is arranged to be located adjacent a palm of said hand of the user and a stored position adjacent a back side of said hand of the user opposite the palm; and
a cursor tracking mechanism supported on the front face of the housing and arranged to receive a cursor tracking input from the user to control a cursor position on a desktop environment of the computer;
the cursor tracking mechanism being positioned on the front face of the housing so as to be arranged to receive input from a thumb of said hand of the user in the working position of the housing.

2. The device according to claim 1 wherein there is provided a click button on one of the sides of the housing, the click button being arranged to generate a computer click signal when depressed by a user.

3. The device according to claim 2 wherein the click button is positioned on the side of the housing so as to be arranged to be accessible by said finger of the user received in the strap member.

4. The device according to claim wherein the click button corresponds to a left-click signal.

5. The device according to claim 1 wherein an upward input on the cursor tracking mechanism towards the top end of the housing in the longitudinal direction is arranged to generate an upward signal corresponding to an upward movement of the cursor position in the desktop environment of the computer.

6. The device according to claim 1 wherein the strap member is adjustable in relation to the housing such that a dimension of the opening between the strap member and the rear face is adjustable.

7. The device according to claim 1 wherein there is provided a first click button on one of the sides of the housing which is arranged to generate a left-click signal when depressed by a user and a second click button on the top end of the housing which is arranged to generate a right-click signal when depressed by a user.

8. The device according to claim 1 wherein there is provided a first click button on one of the sides of the housing which is arranged to generate a left-click signal when depressed by a user and a second click button independently located on the same side of the housing which is arranged to generate a right-click signal when depressed by a user.

9. The device according to claim 1 wherein there is provided a click button on one of the sides of the housing and a toggle switch independently located on the housing, the click button being arranged to generate a left-click signal when depressed by a user in a first mode of the toggle switch and being arranged to generate a right-click signal when depressed by a user in a second mode of the toggle switch.

10. The device according to claim 1 wherein there is provided a connecting member coupled to the top end of the housing and arranged for connection to the computer.

11. A computer mouse input device arranged for transmitting inputs from a user to a computer, the device comprising:
a housing arranged to be gripped in a hand of the user, the housing having opposing front and rear faces which extend in a longitudinal direction between opposing top and bottom ends, and a pair of sides extending in the longitudinal direction along opposing sides of the front and rear faces;
a strap member supported on the housing to project from the rear face, the strap member defining an opening between the strap member and the rear face which extends in a lateral direction across the rear face perpendicularly to the longitudinal direction so as to be arranged to receive a finger of said hand of the user extending in the lateral direction therethrough between the strap member and the rear face of the housing;
the strap member being arranged to receive the finger of the user therein such that the housing is readily pivotal from a working position in which the housing is arranged to be located adjacent a palm of said hand of the user and a stored position adjacent a back side of said hand of the user opposite the palm;
a cursor tracking mechanism supported on the front face of the housing and arranged to receive a cursor tracking input from the user to control a cursor position on a desktop environment of the computer;
the cursor tracking mechanism being positioned on the front face of the housing so as to be arranged to receive input from a thumb of said hand of the user in the working position of the housing;
a click button on one of the sides of the housing, the click button being arranged to generate a computer left-click signal when depressed by a user;
the click button being positioned on the side of the housing so as to be arranged to be accessible by said finger of the user which is received in the strap member.

12. A method of providing inputs to a computer, the method comprising:
providing an input device comprising: a housing having opposing front and rear faces which extend in a longitudinal direction between opposing top and bottom ends, and a pair of sides extending in the longitudinal direction along opposing sides of the front and rear faces; a strap member supported on the housing to project from the rear face and defining an opening between the strap member and the rear face which extends in a lateral direction across the rear face perpendicularly to the longitudinal direction; and a cursor tracking mechanism supported on the front face of the housing and arranged to receive a cursor tracking input from the user to control a cursor position on a desktop environment of the computer;
inserting a finger of a hand of the user in the lateral direction through the opening between the strap member and the rear face of the housing such that the housing is arranged to be gripped in the hand of the user;
controlling the cursor tracking mechanism by providing inputs using a thumb of said hand of the user within which the housing is gripped in a working position of the housing located adjacent a palm of said hand of the user; and
pivoting the housing about said finger of the user received between the strap member and the rear face of the housing from the working position to a stored position adjacent a back side of said hand of the user opposite the palm.

13. The method according to claim 12 including providing a click button on one of the sides of the housing and generating a computer click signal by depressing the button with a finger of the user.

14. The method according to claim 13 including locating the click button on the side of the housing and depressing the button with said finger of the user which is received between the strap member and the rear face of the housing.

15. The method according to claim 13 wherein the click button corresponds to a left-click signal.

16. The method according to claim 12 including generating an upward signal corresponding to an upward movement of the cursor position in the desktop environment of the computer by providing an upward input on the cursor tracking mechanism towards the top end of the housing in the longitudinal direction thereof.
